(19) United States
(12) Patent Application Publication
(10) Pub. No.: US 2022/0316509 A1
(43) Pub. Date: Oct. 6, 2022

(54) LOCKING MECHANISM FOR MODULAR COMPONENTS

(71) Applicant: Tiesda YOU, Bang Phli Samutprkarn (TH)

(72) Inventor: Tiesda YOU, Bang Phli Samutprkarn (TH)

(21) Appl. No.: 17/608,075

(22) PCT Filed: May 4, 2020
(86) PCT No.: PCT/IB2020/054180

§ 371 Date: Nov. 1, 2021

(30) Foreign Application Priority Data
May 2, 2019 (NZ) 753120

(51) Int. Cl. F16B 7/04; B63B 32/60; F16B 7/18; F16B 2/04

(52) U.S. Cl. CPC F16B 7/042; B63B 32/60; F16B 7/187; F16B 2/04

(57) ABSTRACT

The present invention provides an improved locking mechanism for securely connecting modular or detachable components. The locking mechanism includes a male and female portion associated with, respectively, a first and second modular component, the male portion having a slit defining a first and second finger, the locking mechanism having a spreading means provided by a pressure bolt mechanism including a pressure bolt, wherein the pressure bolt is configured to, when turned by up to substantially 1 revolution, move the first and second fingers from a closed position wherein the first and second fingers are substantially parallel to one another, to a spread position wherein the first and second fingers abut an interior surface of the female portion, thereby connecting the first and second modular component.

### FIELD OF THE INVENTION

The present invention relates to a locking mechanism for modular or detachable components. The invention has particular application for connecting together modular components of aquatic foils, specifically the fuselage and wing portions. However, the invention may be used for the engagement and locking together of a wide variety of other modular components, not only parts of aquatic craft or accessories therefor, but also parts of other sporting apparatus such as cycles and fishing gear, as well as parts of furniture.

### BACKGROUND

Aquatic foils are configured to lift a craft into a “foiling” position during travel. They typically comprise a “foil mast” extending from an underside of the craft, an elongate “fuselage” portion connected to the foil mast, and front and tail wings extending, respectively, from the front and tail ends of the fuselage to generate lift.

While the front and/or tail wings can in some cases be manufactured integrally with the fuselage, most commonly these components are modular/detachable and configured for assembly and disassembly by the user.

A number of attachment means are commonly used for connecting the wings to the fuselage. These can include simple bolts or screws, wherein the wings and fuselage are arranged at an overlap and the bolts or screws are passed through both components.

They can also include flanged arrangements consisting of a female portion on one component (for example the wing), and a complementary male portion on the other component that slots into the female portion. Locking together of the flanged portions can be achieved by means of bolts or screws, and/or by means of, for example, a friction fit based on appropriately tapered profiles of the flanged portions.

Of course, many other modular components from a variety of different technical fields also commonly utilise the connection means mentioned above.

However, conventional attachment/connection means tend to have a number of drawbacks. Bolts or screws may struggle to provide an adequately sturdy connection, and in addition require multiple components and a relatively intricate and time-consuming assembly process. Flanged or friction-fit arrangements require a high degree of dimensional precision to be effective, making them relatively difficult and expensive to manufacture; and in addition may often require additional locking components to achieve a fully sturdy connection.

Accordingly, it is an object of the present invention to provide a locking mechanism for modular/detachable components that achieves a sturdy connection between the components while also being quick, easy and convenient to use. At the very least, it is an object of the present invention to provide the public with a useful choice.

### STATEMENTS OF THE INVENTION

According to a first aspect of the invention, there is provided a locking mechanism for connecting a first and second modular component, the locking mechanism comprising:

an elongate male portion configured to, in use, be associated with the first component, the male portion configured to, in use, engage a complementary female portion associated with the second component
wherein the male portion comprises a slit extending along a portion of its length, the slit defining a first and second finger, wherein, in use, the male and female portions are engaged together and a spreading means moves the first and second fingers from a closed position wherein the first and second fingers are substantially parallel to one another, to a spread position wherein the first and second fingers abut an interior surface of the female portion, thereby connecting the first and second modular component,
wherein the spreading means is provided by a pressure bolt mechanism comprising a pressure bolt, wherein the pressure bolt is configured to move the first and second fingers into the spread position on being turned by up to substantially 1 revolution.

Preferably, an interior cross-section of the female portion is greater than a cross-section of the first and second fingers when in the closed position, but lesser than a total cross-sectional area described by the first and second fingers when in the spread position, such that, in the spread position, the first and second fingers exert a force on the interior surface of the female portion to connect the first and second modular component.

Preferably, an end of the slit comprises a hinge means configured to facilitate movement of the fingers into the spread position.

Preferably, the hinge means is provided by an eyelet formation.

Preferably, the pressure bolt is configured to move the first and second fingers into the spread position on being turned by up to substantially one half of a revolution.

Preferably, the pressure bolt mechanism comprises a threaded aperture extending from an exterior surface of the first finger to the slit, wherein the pressure bolt comprises a complementary thread and is disposed in the threaded aperture, such that, in use, the pressure bolt moves downwardly in the threaded aperture when turned, bearing against the second finger and causing the first and second fingers to move to the spread position.

Preferably, the pressure bolt mechanism further comprises an access aperture associated with the female portion and configured to, in use, align with the threaded aperture to permit a tool to access and turn the pressure bolt.

Preferably, the locking mechanism comprises additional securement means on the male and/or female portion to further reinforce the connection between the first and second modular component.

Preferably, the additional securement means are provided by complementary securement regions on the male and female portion.

Preferably, the complementary securement regions comprise, on the finger(s) of the male portion, a protrusion(s) or stub(s), and on the interior surface of the female portion, a complementary notch(es), groove(s) or aperture(s), wherein the respective formations engage and lock with one another in use.

Alternatively, the complementary securement regions comprise roughened or serrated portions on the male and female portion to increase friction therebetween.

Alternatively, the additional securement means is provided by the female portion having a tapered profile with a relatively narrow opening such that the fingers of the male portion are able to pass through the opening when in the closed position but, once in the spread position, are prevented from moving out of the female portion in use.

Preferably, the pressure bolt mechanism is configured such that a distance between the first and second modular component may be adjusted in use.

Preferably, the pressure bolt mechanism comprises a plurality of spaced access apertures associated with the female portion, any one of which can be aligned with the pressure bolt on the male portion to connect the first and second modular component.

Preferably, the male and female portion are disposed directly on, or connected directly to, the first and second modular component (respectively).

Alternatively, the male and/or female portion is provided on an intermediate component, with the respective modular component being affixed to the intermediate component.

Preferably, the first or second modular component comprises, respectively, a male or female portion associated with its either end, such that the first or second modular component may be connected to the second or first modular component at its either end.

Preferably, the first and second modular component comprise components of an aquatic craft or accessory therefor.

More preferably, the first and second modular component comprise a fuselage and wing of an aquatic foil.

According to another aspect of the invention, there is provided a modular component having associated therewith an elongate male portion of a locking mechanism for connecting the component to another modular component, the male portion configured to, in use, engage a complementary female portion associated with the other modular component,

wherein the male portion comprises a slit extending along a portion of its length, the slit defining a first and second finger, wherein, in use, the male and female portions are engaged together and a spreading means moves the first and second fingers from a closed position
wherein the first and second fingers are substantially parallel to one another, to a spread position wherein the first and second fingers abut an interior surface of the female portion, thereby connecting the modular components,
wherein the spreading means is provided by a pressure bolt mechanism comprising a pressure bolt, wherein the pressure bolt is configured to move the first and second fingers into the spread position on being turned by up to substantially 1 revolution.

According to another aspect of the invention, there is provided a first and second modular component,

wherein the first component has associated therewith an elongate male portion of a locking mechanism for connecting the first and second component, the male portion configured to, in use, engage a complementary female portion associated with the second modular component,
wherein the male portion comprises a slit extending along a portion of its length, the slit defining a first and second finger, wherein, in use, the male and female portions are engaged together and a spreading means moves the first and second fingers from a closed position wherein the first and second fingers are substantially parallel to one another, to a spread position wherein the first and second fingers abut an interior surface of the female portion, thereby connecting the first and second modular component,
wherein the spreading means is provided by a pressure bolt mechanism comprising a pressure bolt, wherein the pressure bolt is configured to move the first and second fingers into the spread position on being turned by up to substantially 1 revolution.

According to another aspect of the invention, there is provided an aquatic craft or accessory therefor comprising at least one component having a male portion of a locking mechanism substantially as described above.

Preferably the aquatic craft is an aquatic foil comprising a fuselage and one or more wings as modular components configured to be connected by one or more locking mechanisms substantially as described above.

The present invention provides a number of advantages, including:
Providing a locking mechanism that enables a firm and secure connection to be achieved between modular components;
At the same time, providing a locking mechanism that is easy and convenient to use and that allows quick and efficient assembly and disassembly of modular components;
Providing a locking mechanism that is elegant and streamlined;
Providing a locking mechanism that can readily be configured so as to be watertight and hence suitable for use in marine environments;
At the very least, providing the public with a useful choice.

### DESCRIPTION

Further aspects and advantages of the present invention will become apparent from the following description which is given by way of example only and with reference to the accompanying drawings in which:

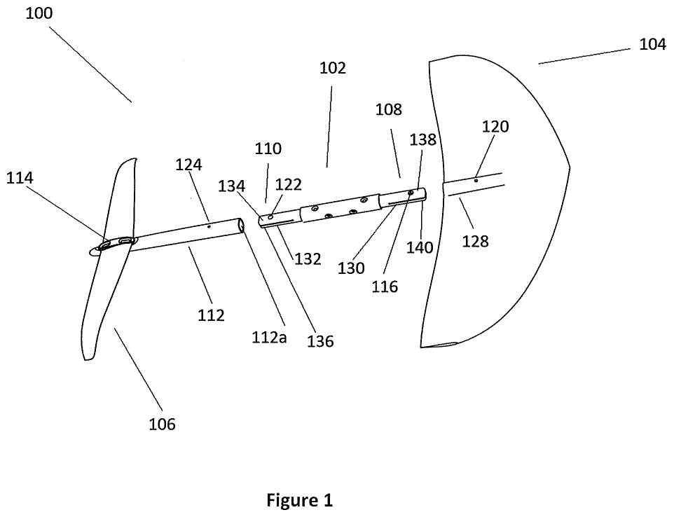

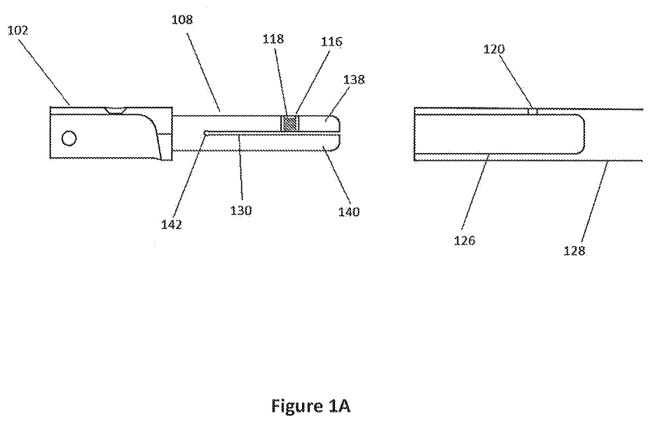

FIG. 1 is a partially exploded view of a locking mechanism according to one embodiment of the present invention, shown in relation to a fuselage, front and tail wing of an aquatic foil;

FIG. 1A is a cross-sectional view showing the male and female portion of the locking mechanism of FIG. 1 at the front wing of the foil;

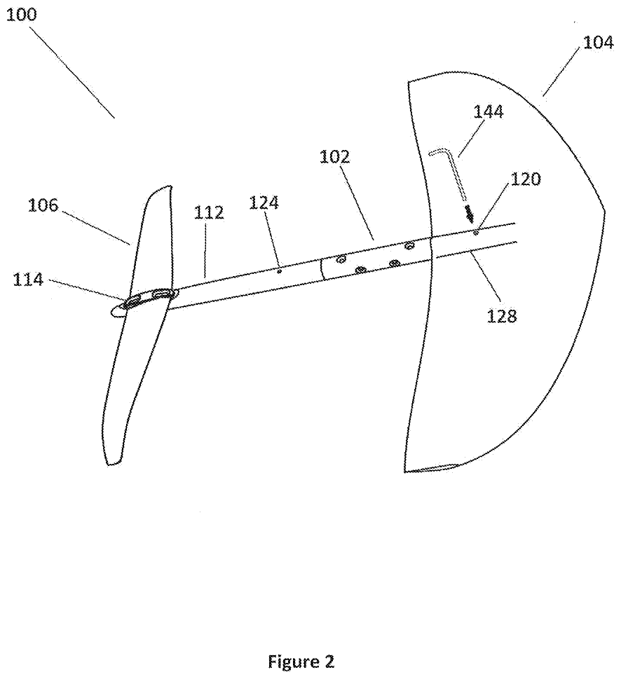

FIG. 2 is a view of the locking mechanism of FIG. 1 when assembled;

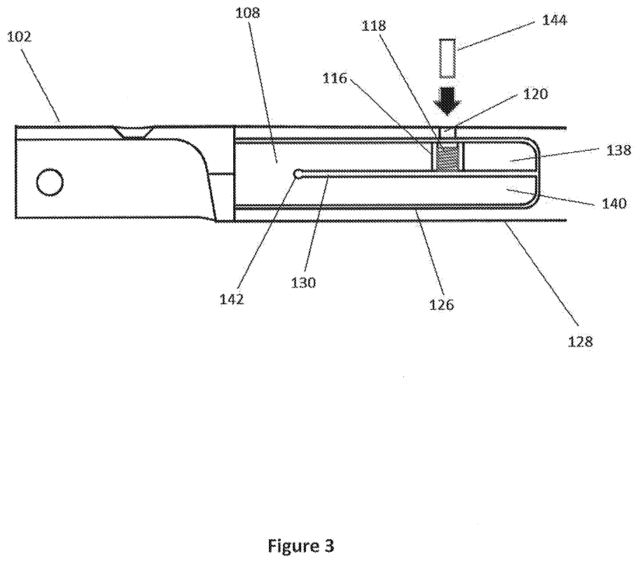

FIG. 3 is a cross-sectional view showing engagement between the male and female portion of the locking mechanism of FIG. 1 at the front wing of the foil;

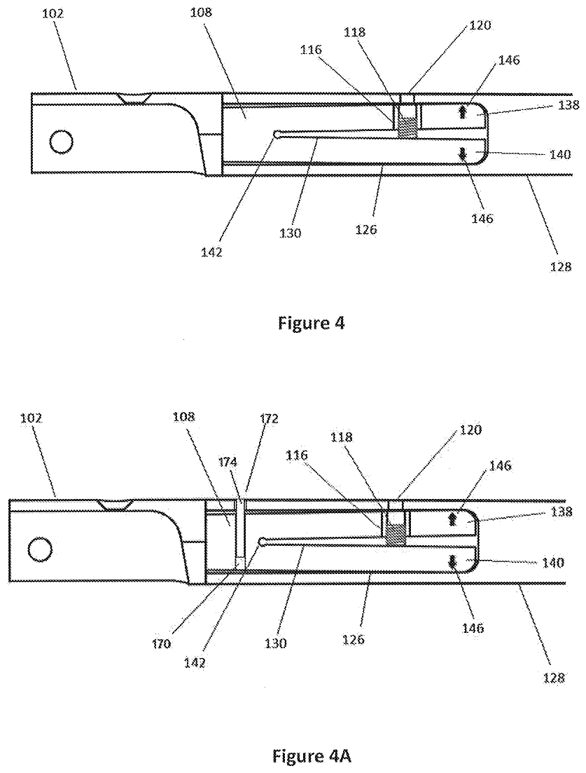

FIG. 4 is a cross-sectional view showing the first and second finger of the male portion of the locking mechanism of FIG. 1 being moved into the spread position to connect the front wing and the fuselage;

FIG. 4A is a cross-sectional view showing a variation on the locking mechanism of FIG. 1;

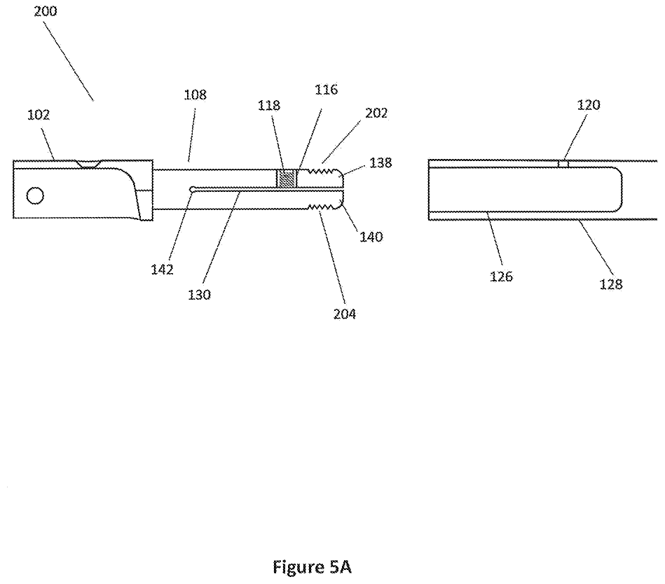

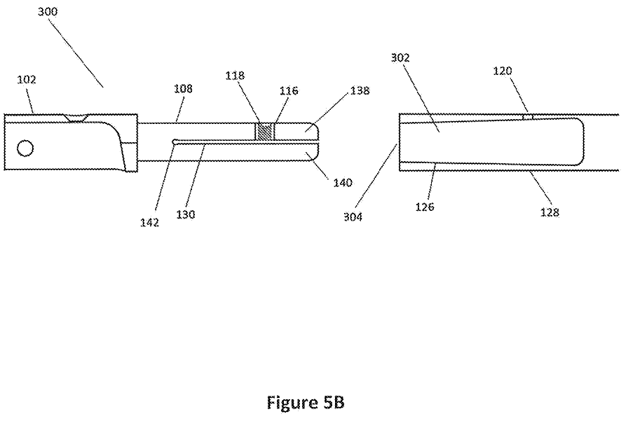

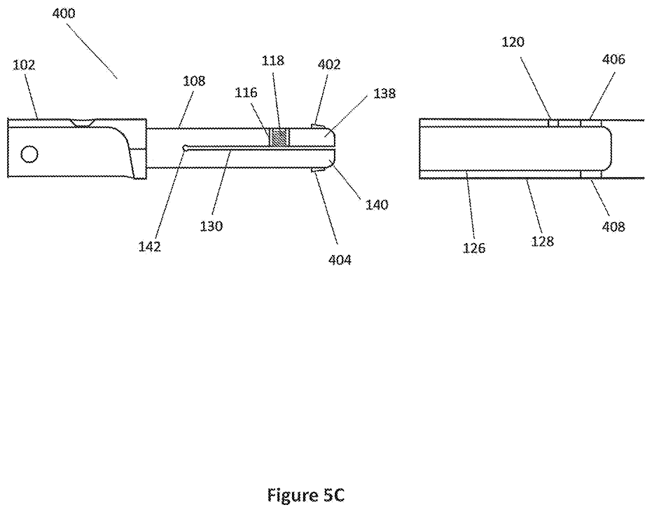

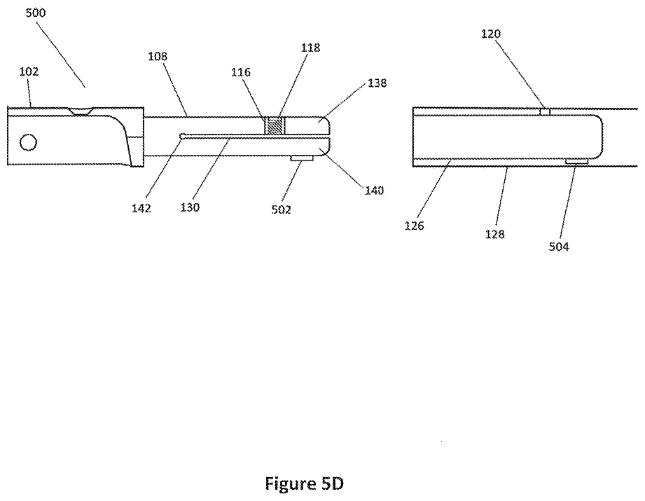

FIGS. 5A-5D are cross-sectional views showing various embodiments of the additional securement means of the locking mechanism of the invention; and

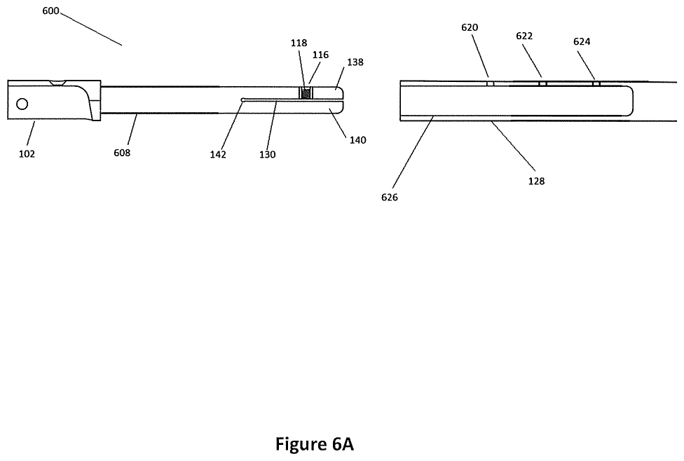

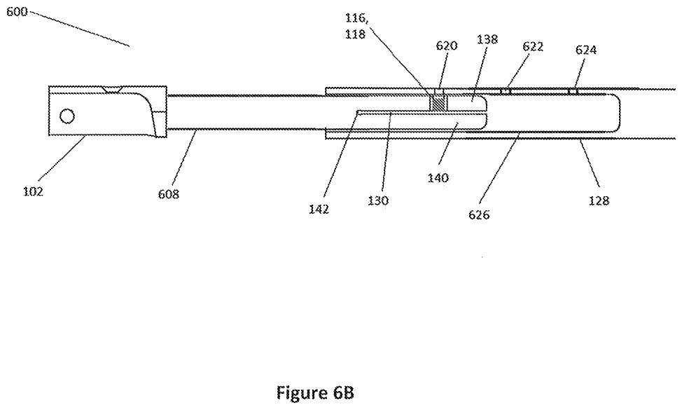

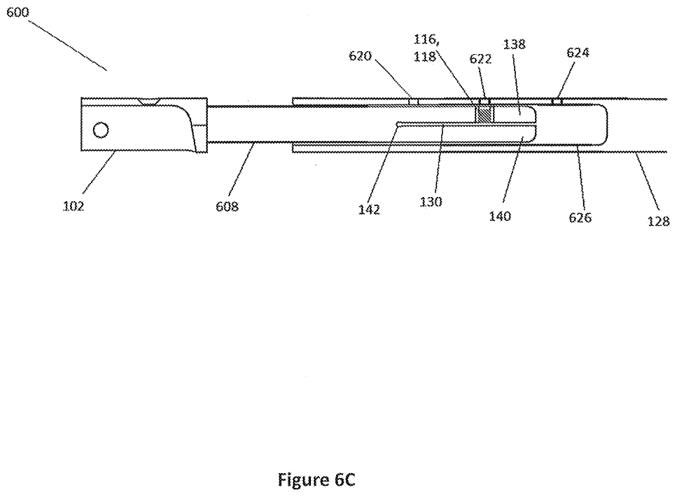

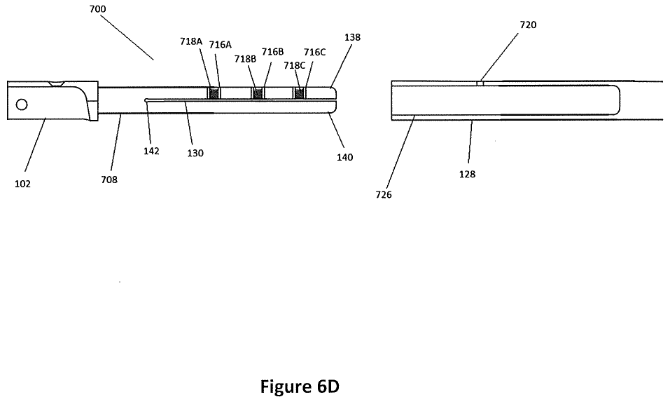

FIGS. 6A-6D are cross-sectional views showing further embodiments of the locking mechanism of the invention.

The following description will describe the invention in relation to examples and/or drawings. The invention is in no way limited to the example(s) and/or drawings as they are purely to exemplify the invention only. Possible variations and modifications would be readily apparent to a person skilled in the art without departing from the scope of the invention.

The Figures show the locking mechanism used to connect modular (i.e. detachable) components of an aquatic foil (more particularly a surf foil); namely, the fuselage and front and tail wings of the foil.

However, it will be understood that this is exemplary only and the locking mechanism of the invention can equally be used to connect a wide range of modular components belonging to different technical fields. For instance, the locking mechanism can be used in conjunction with modular components of aquatic craft, including but not limited to stand-up paddleboards, surfboards, windsurfs, kitesurfs, boats, kayaks, et cetera; or accessories for aquatic craft, including but not limited to paddles or booms. The locking mechanism can equally be used with modular components of other sporting equipment, such as cycles or fishing paraphernalia; as well as non-sporting-related modular components, such as those of furniture.

FIG. 1 is a partially exploded view of the locking mechanism (generally indicated by 100) of the present invention used to connect a front wing (104) and a tail wing (106) of a foil to a fuselage (102) of the foil. FIG. 1A is a cross-sectional view showing in more detail the male (108) and female (126) portions of the locking mechanism (100). FIG. 2 shows the locking mechanism (100) connecting the front (104) and tail (106) wings to the fuselage (102) in use.

In this embodiment, the fuselage (102) has associated with it the male portion (108, 110), as described below, while the front and tail wings (104, 106) each have associated with them the corresponding female portion (126). However, it will be appreciated that the inverse configuration is equally possible, with the male portion associated with the wings and the female portion associated with the fuselage.

In this embodiment, the fuselage (102) comprises a male portion (108, 110) at its either end, for connecting the fuselage (102) to, respectively, the front wing (104) and the tail wing (106). Each male portion (108, 110) comprises a slit (130, 132) extending back towards the fuselage (102). The respective slits (130, 132) define a first and second finger (134, 136; 138, 140) on the respective male portions (108, 110). A hinge means (142 in FIG. 1A), in this embodiment provided by an eyelet formation, is provided at the end of the slit (130) and promotes movement of the fingers (138, 140) into the spread position in use.

A complementary female portion is associated with the front wing (104) and the tail wing (106), and engages with the respective male portion (108, 110) in use.

In the case of the tail wing, the female portion (112a) is provided on an intermediate component (112), being an elongate linking component which, in use, forms a continuation of the fuselage (102) as seen in FIG. 2. The tail wing (106) is connected to a distal end of the intermediate component (112) via conventional attachment means such as bolts (114). This configuration is advantageous in reducing the length of the components of the fuselage, enabling convenient storage and transportation when disassembled.

In the case of the front wing (104), the female portion (126 in FIG. 1A) is provided by a tubular portion located in a central recess (128) on the main body of the front wing (104). It will be understood however that in other embodiments the female portion may equally be provided by the central recess (128) itself, such as an existing central recess on a conventional foil wing, with an access aperture formed thereon to allow access to the pressure bolt in use (note, many conventional front foil wings already have at least one aperture on their central recess, which if appropriately configured can be used as the access aperture of the present invention).

As shown in FIGS. 3 and 4, female portion (126) has an interior cross-section that is greater than a cross-section of the first and second fingers (138, 140) when in the closed position, but lesser than a total cross-sectional area described by the first and second fingers (138, 140) when in the spread position, such that, in the spread position, the first and second fingers (138, 140) exert a force on the interior surface of the female portion (126) to effect a secure connection between the modular components.

The locking mechanism comprises a spreading means associated with the respective male portions (108, 110) the spreading means being provided by a pressure bolt mechanism. In this embodiment, each pressure bolt mechanism comprises a threaded aperture (116, 122) extending from an exterior surface of the first finger (134, 138) of the male portion (108, 110) to the slit (130, 132). A pressure bolt (118 in FIG. 1A) having a complementary thread is located in the threaded aperture (116). The term “pressure bolt” has its ordinary meaning as it would be understood by one skilled in the art: namely a bolt or equivalent component which, when turned or otherwise actuated, exerts pressure on another component.

An access aperture (120, 124) is provided on, respectively, the front wing (104) and intermediate component (112) which, when the male and female portions are engaged, aligns with the respective threaded aperture (116, 122) as seen in FIGS. 3 and 4.

A tool (144 in FIGS. 2 and 3), such as a torque wrench, is then inserted through the access aperture (120) into contact with the pressure bolt (118). Turning the tool (144) and hence the pressure bolt (118) causes the pressure bolt (118) to move downwardly in the threaded aperture (116), bearing against the second finger (140) and causing the first and second finger (138, 140) to move away from one another into the spread position.

In this embodiment, a half-turn of the tool (144) (and hence the pressure bolt (118)) is sufficient to achieve this. This is advantageous as it means the pressure bolt behaves in a “quick-release” manner, enabling quick and convenient connection (and disconnection) of the modular components with a simple half-turn of the torque wrench.

More generally, the firmness of the connection can be readily adjusted as required by simply turning the bolt by a greater or lesser degree to increase or decrease the spread of the fingers. The locking mechanism of the present invention is accordingly versatile as it is compatible with a range of profiles of the female portion.

As shown in FIG. 4, in moving into the spread position, the first and second fingers (138, 140) abut the interior surface of the female portion (126), exerting a force (generally indicated by arrows 146) that locks the male and female portion (108, 126) together, thereby connecting the modular components, being in this case the fuselage and the wing.

The process is applied in reverse to disassemble the components; namely, inserting the tool (202) through the access aperture (120), turning the pressure bolt (118) in the reverse direction to cause it to move upwardly away from the second finger (140) such that the first and second finger return to their closed position, and disengaging the male and female portions of the locking mechanism.

As shown in FIG. 4, the tight fit of the first and second fingers (138, 140) against the interior surface of the female portion (126) means that, in use, the system is watertight. In particular, if correctly configured and assembled, water will not pervade into the region of the male portion (108) where the pressure bolt (118) is located, meaning the locking mechanism will be relatively resistant to corrosion or other water-related damage in use.

Other suitable configurations for the spreading means may be envisaged, besides the pressure bolt mechanism. For instance, the spreading means may be provided by a biasing means, such as a spring. The spring may be disposed between the fingers and urge them into the spread position, wherein a user forces the fingers together to insert the male portion into the female portion and the fingers are subsequently urged back into the spread position by the spring.

In some embodiments, a supplementary bolt mechanism may be provided, to further promote the sturdy connection between the male and female portion (108, 126). An example of such a supplementary bolt mechanism is shown in FIG. 4A. The male portion (108) is provided with a supplementary aperture (170), located on the “solid” section of the male portion (108) i.e. to the left of the eyelet (142) that defines the start of the first and second finger. The female portion (126) has associated therewith a corresponding supplementary aperture (172), configured to, in use, align with the supplementary aperture (170) on the male portion (108) simultaneously with alignment being achieved between the threaded aperture (116) and the access aperture (120). A supplementary bolt (174) or similar fastener is passed through the apertures (170, 172), to reinforce the connection between the male and female portion (108, 126) and hence the first and second modular component in use.

The supplementary bolt mechanism can of course be configured in a range of different ways; the skilled person will readily devise appropriate configurations.

FIGS. 5A-5D show various embodiments of the additional securement means of the locking mechanism of the present invention. It will be understood that the additional securement means are in all cases provided in addition to the spreading means.

In FIG. 5A, the additional securement means is provided by serrated regions (202, 204) on the first and second fingers (138, 140) of the male portion (108) to provide increased friction with the interior surface of the female portion (126) in use. Though not shown, it will be understood that the female portion (126) may have a complementary serrated region(s) on its interior surface to further promote the frictional connection.

In FIG. 5B, the additional securement means is provided by the tapered profile (302) of the female portion, wherein an opening (304) of the female portion is relatively narrow such that the fingers (138, 140) must be in the closed position to pass through the opening (304) but, once inside and in the spread position, are prevented from moving back out through the opening (304).

In FIGS. 5C and 5D, the additional securement means is provided by complementary securement regions on the male (108) and female (126) portions which together have a “click and lock” configuration. In FIG. 5C, the fingers (138, 140) of the male portion (108) are provided with tapered stubs (402, 404) that are biased outwardly but able to “recede” into the respective fingers (138, 140) to allow the fingers to enter the female portion. The tapered profile of the stubs (402, 404) is advantageous in this regard, as contact with the leading edge of the female portion (126) will cause the stubs (402, 404) to retract into the “receded” position. The interior surface of the female portion (126) has complementary apertures (406, 408). On reaching the apertures (406, 408), the stubs (402, 404) move into their outwardly-biased position, mechanically locking the male and female portions (108, 126) together.

In FIG. 5D the second finger (140) of the male portion (108) is provided with a stub (502) that is likewise biased outwardly but able to “recede” into the second finger (140) to enable engagement with the female portion (126). The square profile of the stub (502) means it would need to be manually depressed prior to engaging the male (108) and female (126) portions, which may be advantageous in some applications. The interior surface of the female portion (126) has a complementary groove (504). On reaching the groove (504), the stub (502) moves into its outwardly-biased position, again mechanically locking the male and female portions (108, 126) together.

FIGS. 6A-6D show further preferred exemplary embodiments of the present invention, similar in many respects to the embodiments of FIGS. 1-4. The difference is that in the embodiments of FIGS. 6A-6D the locking mechanism, and in particular the pressure bolt mechanism, is configured to allow the first and second modular component to be connected at varying distances from one another.

In FIGS. 6A-6C, the female portion (626) has associated with it a plurality of spaced access apertures (620, 622, 624). Any one of these can be aligned with the pressure bolt (118) on the male portion (608), and the pressure bolt turned to move the first and second fingers (138, 140) into the spread position as described above.

It will be appreciated that the female portion (626) and the male portion (608) are longer than those in FIGS. 1-4, to allow for the multiple access apertures (620, 622, 624). Likewise the male and female portion (708, 726) of FIG. 6D, discussed below, are also longer than those of FIGS. 1-4.

By selecting a particular aperture (620, 622, 624), the distance between the first and second modular component can be varied. This is illustrated in FIGS. 6B and 6C. In FIG. 6B, the leftmost aperture (620) is aligned with the pressure bolt (118), meaning a relatively large amount of the male portion (608) remains outside of the female portion (626), in turn meaning the fuselage (102) is relatively far to the left of the wing (128 et cetera). In FIG. 6C, the middle aperture (622) is aligned with the pressure bolt (118), meaning a greater amount of the male portion (608) is disposed within the female portion (626), in turn meaning the fuselage (102) is farther to the right, that is to say, closer to the wing (128 et cetera).

FIG. 6D shows a possible alternative manner in which the pressure bolt mechanism can be configured to allow the first and second modular component to be connected at varying distances from each other. In this embodiment the male portion (708) is configured with a plurality of spaced pressure bolts (718A, 718B, 718C) disposed within respective threaded apertures (716A, 716B, 716C).

Any one of the pressure bolts (718A, 718B, 718C) can be aligned with the access aperture (720) on the female portion (726), and the relevant pressure bolt then turned to move the first and second fingers (138, 140) into the spread position as described above. Once again, the choice of a particular one of the pressure bolts (718A, 718B, 718C) will affect the length of the male portion (708) that is disposed within the female portion (726), and thus how far apart the fuselage (102) and wing (128 et cetera) are spaced from each other.

It will be appreciated that the FIG. 6D embodiment may be less optimal than that of FIGS. 6A-6C; and/or may require certain modifications such as additional waterproofing or anti-corrosion measures (e.g. of the pressure bolts).

The locking mechanism of the present invention may be manufactured from any suitable material. In a particularly preferred exemplary embodiment, the male portion is formed from aluminium, the female portion is formed from carbon fibre, and the pressure bolt is formed from a corrosion-resistant material such as stainless steel or titanium. However, a range of other materials are suitable for the male and female portions; such as, for the male portion, titanium, glass fibre, carbon fibre, or a thermoplastic; and for the female portion, glass fibre, aluminium, or a thermoplastic. The skilled person may envisage still other suitable materials.

It will be understood that various combinations of the above-discussed additional securement means are possible, and that still further configurations for the additional securement may be envisaged by the skilled person.

It will accordingly be appreciated that the locking mechanism of the present invention provides a means of connecting modular components that is simple and convenient to use, meaning assembly and disassembly of the components is quick and easy. At the same time, the locking mechanism of the present invention ensures a secure connection between the components. In addition, the locking mechanism of the present invention is elegant, streamlined, and can readily be configured so as to be watertight and hence suitable for use in marine environments.

It will of course be realized that while the foregoing has been given by way of illustrative example of this invention, all such and other modifications and variations thereto as would be apparent to persons skilled in the art are deemed to fall within the broad scope and ambit of this invention as is hereinbefore described.

If any reference numeral(s) is/are used in a claim or claims then such reference numeral(s) should not be considered as limiting the scope of that respective claim or claims(s) to any particular embodiment of the drawings.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. it will be taken to mean an inclusion of not only the listed components it directly references, but also other non-specified components or elements. This rationale will also be used when the term ‘comprised’ or ‘comprising’ is used in relation to one or more steps in a method or process.

1. A locking mechanism for connecting a first and second modular component, the locking mechanism comprising:
an elongate male portion configured to, in use, be associated with the first component, the male portion configured to, in use, engage a complementary female portion associated with the second component,
wherein the male portion comprises a slit extending along a portion of its length, the slit defining a first and second finger, wherein, in use, the male and female portions are engaged together and a spreading means moves the first and second fingers from a closed position wherein the first and second fingers are substantially parallel to one another, to a spread position wherein the first and second fingers abut an interior surface of the female portion, thereby connecting the first and second modular component,
wherein the spreading means is provided by a pressure bolt mechanism comprising an aperture extending from an exterior surface of the first finger to the slit, and a pressure bolt disposed in the aperture, such that, in use, the pressure bolt moves downwardly in the aperture when turned in a first direction, bearing against the second finger and causing the first and second fingers to move to the spread position, wherein the aperture is configured to, in use, align with an access aperture on the female portion to permit a tool to access and turn the pressure bolt,
wherein the pressure bolt is configured in a “quick-release” manner, to move the first and second fingers into the spread position on being turned in the first direction by up to substantially 1 revolution, and to move the first and second fingers back to the closed position on being turned in a second, opposite, direction by up to substantially 1 revolution,
wherein, when the first and second fingers are in the closed position, the pressure bolt is disposed level with or below the exterior surface of the first finger, such that the male and female portions can be engaged and disengaged without removal of the pressure bolt from the aperture.

2. The locking mechanism of claim 1, wherein an interior cross-section of the female portion is greater than a cross-section of the first and second fingers when in the closed position, but lesser than a total cross-sectional area described by the first and second fingers when in the spread position, such that, in the spread position, the first and second fingers exert a force on the interior surface of the female portion to connect the first and second modular component.

3. The locking mechanism of claim 1, wherein an end of the slit comprises a hinge means configured to facilitate movement of the fingers into the spread position.

4. The locking mechanism of claim 3, wherein the hinge means is provided by an eyelet formation.

5. The locking mechanism of claim 1, wherein the pressure bolt is configured to move the first and second fingers into the spread position on being turned by up to substantially one half of a revolution.

6. The locking mechanism of claim 1, wherein the aperture is threaded and wherein the pressure bolt comprises a complementary thread.

7. The locking mechanism of claim 1, wherein the locking mechanism comprises additional securement means on the male and/or female portion to further reinforce the connection between the first and second modular component.

8. The locking mechanism of claim 7, wherein the additional securement means is provided by complementary securement regions on the male and female portion.

9. The locking mechanism of claim 8, wherein the complementary securement regions comprise, on the finger(s) of the male portion, a protrusion(s) or stub(s), and on the interior surface of the female portion, a complementary notch(es), groove(s) or aperture(s), wherein the respective formations engage and lock with one another in use.

10. The locking mechanism of claim 8, wherein the complementary securement regions comprise roughened or serrated portions on the male and female portion to increase friction therebetween.

11. The locking mechanism of claim 7, wherein the additional securement means is provided by the female portion having a tapered profile with a relatively narrow opening such that the fingers of the male portion are able to pass through the opening when in the closed position but, once in the spread position, are prevented from moving out of the female portion in use.

12. The locking mechanism of claim 1, wherein the pressure bolt mechanism is configured such that a distance between the first and second modular component may be adjusted in use.

13. The locking mechanism of claim 12, wherein the pressure bolt mechanism comprises a plurality of spaced access apertures associated with the female portion, any one of which can be aligned with the pressure bolt on the male portion to connect the first and second modular component.

14. The locking mechanism of claim 1, wherein the male and female portion are disposed directly on, or connected directly to, the first and second modular component (respectively).

15. The locking mechanism of claim 1, wherein the male and/or female portion is provided on an intermediate component, with the respective modular component being affixed to the intermediate component.

16. The locking mechanism of claim 1, wherein the first or second modular component comprises, respectively, a male or female portion associated with its either end, such that the first or second modular component may be connected to the second or first modular component at its either end.

17. The locking mechanism of claim 1, wherein the first and second modular component comprise components of an aquatic craft or accessory therefor.

18. A modular component having associated therewith an elongate male portion of a locking mechanism for connecting the component to another modular component, the male portion configured to, in use, engage a complementary female portion associated with the other modular component,
wherein the male portion comprises a slit extending along a portion of its length, the slit defining a first and second finger, wherein, in use, the male and female portions are engaged together and a spreading means moves the first and second fingers from a closed position wherein the first and second fingers are substantially parallel to one another, to a spread position wherein the first and second fingers abut an interior surface of the female portion, thereby connecting the modular components,
wherein the spreading means is provided by a pressure bolt mechanism comprising an aperture extending from an exterior surface of the first finger to the slit, and a pressure bolt disposed in the aperture, such that, in use, the pressure bolt moves downwardly in the aperture when turned in a first direction, bearing against the second finger and causing the first and second fingers to move to the spread position, wherein the aperture is configured to, in use, align with an access aperture on the female portion to permit a tool to access and turn the pressure bolt,
wherein the pressure bolt is configured in a “quick-release” manner, to move the first and second fingers into the spread position on being turned in the first direction by up to substantially 1 revolution, and to move the first and second fingers back to the closed position on being turned in a second, opposite, direction by up to substantially 1 revolution,
wherein, when the first and second fingers are in the closed position, the pressure bolt is disposed level with or below the exterior surface of the first finger, such that the male and female portions can be engaged and disengaged without removal of the pressure bolt from the aperture.

19. A first and second modular component,
wherein the first component has associated therewith an elongate male portion of a locking mechanism for connecting the first and second component, the male portion configured to, in use, engage a complementary female portion associated with the second modular component,
wherein the male portion comprises a slit extending along a portion of its length, the slit defining a first and second finger, wherein, in use, the male and female portions are engaged together and a spreading means moves the first and second fingers from a closed position wherein the first and second fingers are substantially parallel to one another, to a spread position wherein the first and second fingers abut an interior surface of the female portion, thereby connecting the first and second modular component,
wherein the spreading means is provided by a pressure bolt mechanism comprising an aperture extending from an exterior surface of the first finger to the slit, and a pressure bolt disposed in the aperture, such that, in use, the pressure bolt moves downwardly in the aperture when turned in a first direction, bearing against the second finger and causing the first and second fingers to move to the spread position, wherein the aperture is configured to, in use, align with an access aperture on the female portion to permit a tool to access and turn the pressure bolt,
wherein the pressure bolt is configured in a “quick-release” manner, to move the first and second fingers into the spread position on being turned in the first direction by up to substantially 1 revolution, and to move the first and second fingers back to the closed position on being turned in a second, opposite, direction by up to substantially 1 revolution,
wherein, when the first and second fingers are in the closed position, the pressure bolt is disposed level with or below the exterior surface of the first finger, such that the male and female portions can be engaged and disengaged without removal of the pressure bolt from the aperture.
